(19) United States
(12) Patent Application Publication
(10) Pub. No.: US 2026/0020722 A1
(43) Pub. Date: Jan. 22, 2026

(54) PIPING BAG HOLDER APPARATUS

(71) Applicant: Jon Ramos, Warwick, RI (US)

(72) Inventor: Jon Ramos, Warwick, RI (US)

(21) Appl. No.: 18/779,354

(22) Filed: Jul. 22, 2024

(51) Int. Cl. A47J 47/16

(52) U.S. Cl. CPC A47J 47/16

(57) ABSTRACT

An apparatus for the decoration of baked goods with icing. The invention is a tall cylinder having an open upper end and two elliptical slots in the curved lateral surface, the elliptical slots being located opposite each other. The apparatus is designed to facilitate the easy filling, closing, and removal of icing piping bags.

### CROSS REFERENCE TO RELATED APPLICATIONS

Not Applicable

### TECHNICAL FIELD

The present invention relates to accessories for decoration of baked goods with icing.

### BACKGROUND

A cookier is one who bakes and decorates cookies, often using a piping bag to deposit icing in a controlled way on said cookies. Piping bags are simple plastic bags filled with icing which can also be used to decorate other baked goods or foodstuffs. The process of filling a piping bag can be tedious and messy. The correct amount of icing to fill a bag is often hard to judge, leading to over- or under-filling. Further, once a piping bag is filled, cookiers must tie off the open end of the bag, which can also be a bothersome process. Historically, cookiers use standard drinking glasses to hold and fill piping bags. These are rarely the correct height and diameter to effectively hold and fill said piping bags. Additionally, standard glasses do not allow the user to grasp the bottom tip of a piping bag, which would make the process of filling and closing a piping bag much easier.

### SUMMARY

An objective of the invention is to ease the process of filling piping bags with the correct amount of icing.

Another objective of the invention is to facilitate the closing or tying-off of filled piping bags.

To fulfill the above-mentioned objectives, according to one embodiment of the present invention, an apparatus for filling and closing piping bags consists of a tall cylinder comprising an open top end and two side openings in the cylinder's curved lateral surface, said side openings being on opposite sides of the cylinder from each other.

A piping bag is inserted in the cylinder and excess plastic is allowed to hang over the top edge. Said piping bag is then filled with icing. The bag is then held in place by the user by pinching the end of said piping bag through said side openings while the excess plastic is collected and the bag is closed.

To those skilled in the art to which this invention relates, many changes in construction and widely different embodiments and applications of the invention will suggest themselves without departing from the scope of the invention as defined herein. The disclosures and the descriptions herein are purely illustrative and are not intended to be in any sense limiting.

### BRIEF DESCRIPTION OF THE DRAWINGS

For a better understanding of the present invention including the features, advantages and specific embodiments, reference is made to the following detailed description along with accompanying Figures, in which:

FIG. 1 is a perspective view of one embodiment of the present invention;

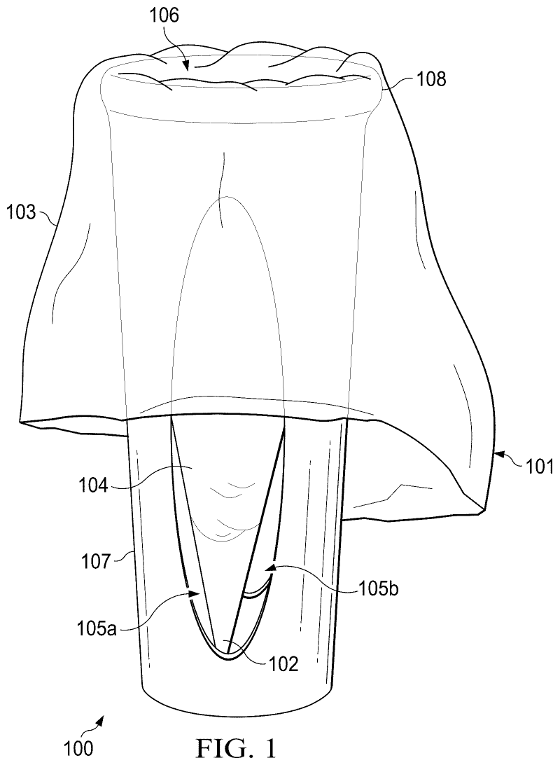

FIG. 2 is a front-side planform view of one embodiment of the present invention;

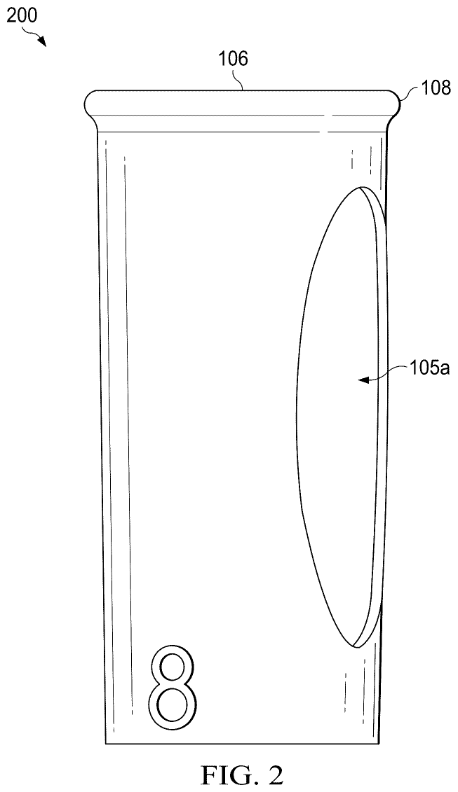

FIG. 3 is a front planform view of one embodiment of the present invention;

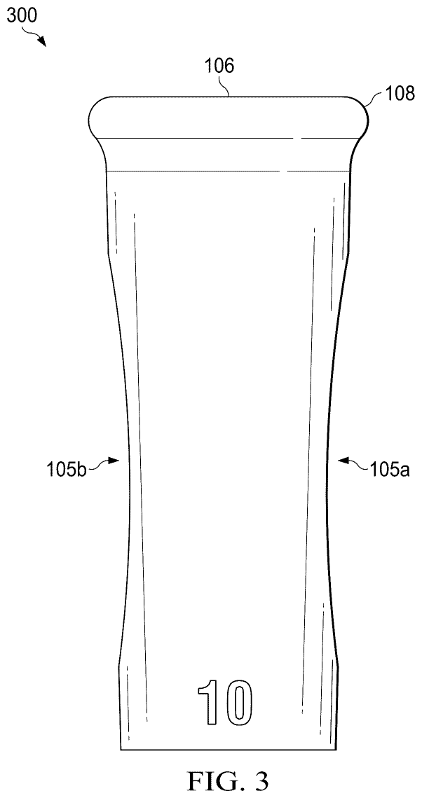

FIG. 4 is a front-side planform view of one embodiment of the present invention; and

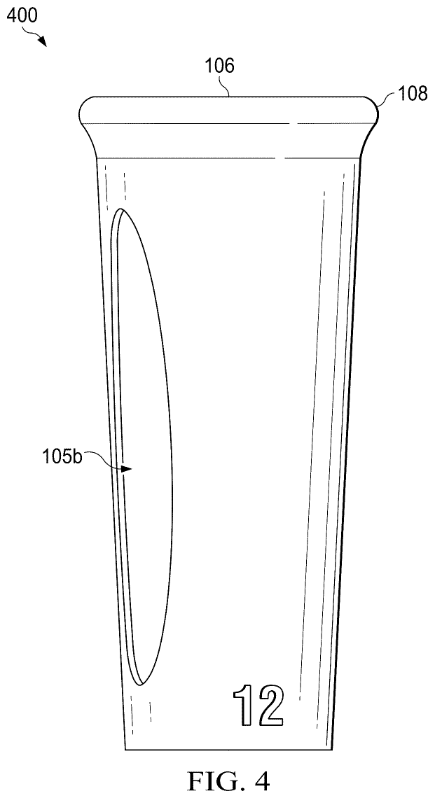

FIG. 5 is a top planform view of one embodiment of the present invention.

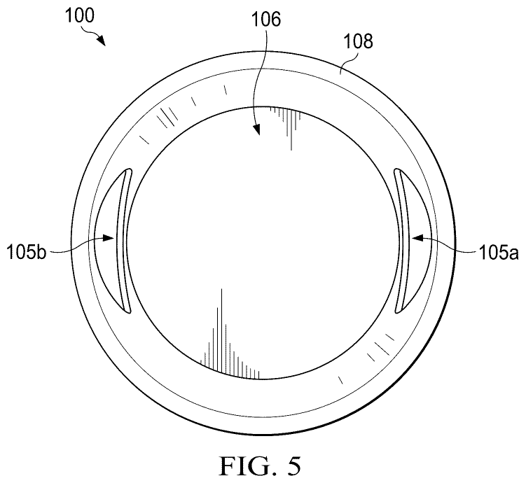

### DETAILED DESCRIPTION

While the making and using of the disclosed embodiments of the present invention is discussed in detail below, it should be appreciated that the invention provides many applicable inventive concepts which can be embodied in a wide variety of specific contexts. some features of the preferred embodiments shown and discussed may be simplified or exaggerated for illustrating the principles of the invention.

Reference will now be made in detail to an embodiment of the present invention.

According to an embodiment of the invention, an apparatus for filling and closing piping bags 100 consists of a tall slightly tapered cylinder 107 comprising an open top end 106 and two elliptical side openings 105a, 105b in the cylinder's curved lateral surface, said elliptical side openings 105a, 105b being on opposite sides of the cylinder 107 from each other; said open top end comprises a thick bulbous rim 108 to aid in holding a piping bag in place.

A piping bag 101 is inserted in cylinder 107 such that the tip 102 is just touching the bottom of said cylinder and excess plastic 103 is draped over the circular upper rim 108 of the upper opening 106 of said cylinder. The open piping bag 101 is then filled with icing 104, using the elliptical side openings 105a, 105b to judge the amount of icing required to fill said piping bag. The bag is then held in place by the user by pinching the tip of said piping bag through said elliptical side openings while the excess plastic is drawn up and collected and the bag is closed by a method such as twisting the open end of said piping bag shut or applying a rubber band or similar. The apparatus is made of a sturdy material such as food-safe PLA plastic.

In an embodiment of the present invention, the dimensions of the type 1 cylinder 200 are sized to accept an 8-inch piping bag, the height of said type 1 cylinder 200 being about 4.79 inches and the diameter of said type 1 cylinder 200 being about 2 inches.

In another embodiment of the present invention, the dimensions of the type 2 cylinder 300 are sized to accept a 10-inch piping bag, the height of said type 2 cylinder 300 being about 6.82 inches and the diameter of said type 2 cylinder being about 2.25 inches.

In a further embodiment of the present invention, the dimensions of the type 3 cylinder 400 are sized to accept a 12-inch piping bag, the height of said type 3 cylinder 400 being about 7.94 inches and the diameter of said type 3 cylinder being about 2.5 inches.

The three types of cylinder are further dimensioned such that they can be nested one inside the other for easy storage.

The invention is an apparatus for facilitating the filling of piping bags with icing, comprising a tapered, graduated cylinder having a lateral curved surface and an upper, open circular face and a bottom face; an opening in the upper circular face of said cylinder; and two side openings in the lateral curved surface of said cylinder. The side openings are dimensioned as elliptical openings.

The side openings are located on opposite sides of the lateral curved surface of said cylinder from each other. The cylinder further comprises a bulbous upper rim around said upper, open circular face opening. The cylinder is made of a sturdy, rigid material. Such as Polylactic acid (PLA) plastic.

The cylinder is dimensioned to accept a piping bag. In a further embodiment the cylinder is dimensioned to accept an 8-inch piping bag. In a further embodiment the cylinder is dimensioned to accept a 10-inch piping bag. In a further embodiment the cylinder, the cylinder is dimensioned to accept a 12-inch piping bag. The invention is the cylinder in combination with a tipless piping bag. The invention is the cylinder in combination with a tipped piping bag.

The invention is an apparatus for facilitating the filling of piping bags with icing comprising a tall, tapered, graduated cylinder, said cylinder comprising an open upper end and two elliptical side openings, said elliptical side openings being located on the lateral curved surface of said cylinder on opposite sides from each other. The cylinder is made of a sturdy, rigid material. The cylinder is made of Polylactic acid (PLA) plastic. The cylinder further comprises a bulbous upper rim around said upper end opening.

In an embodiment, the cylinder is dimensioned to accept an 8-inch piping bag. In an embodiment, the cylinder is dimensioned to accept a 10-inch piping bag. In an embodiment, the cylinder is dimensioned to accept a 12-inch piping bag. The invention is a system for facilitating the filling of piping bags with icing comprising three tall, tapered, graduated cylinders, each of said cylinders comprising an open upper end having a bulbous upper rim and two elliptical side openings, said elliptical side openings being located on the lateral curved surface of said cylinders on opposite sides from each other, said cylinders being dimensioned to accept 8-inch, 10-inch, and 12-inch standard piping bags, respectively, said cylinders being made of a rigid material, said cylinders being dimensioned such that they can be nested inside each other.

The embodiments shown and described above are only exemplary. Even though numerous characteristics and advantages of the invention have been set forth in the foregoing description together with details of the invention, the disclosure is illustrative only and changes may be made within the principles of the invention to the full extent indicated by the broad general meaning of the terms used herein. Various alterations, modifications and substitutions can be made to the invention without departing in any way from the spirit and scope of the invention.

What is claimed is:

1. An apparatus for facilitating the filling of piping bags with icing, comprising:
a tapered, graduated cylinder having a lateral curved surface and an upper, open circular face and a bottom face;
an opening in the upper circular face of said cylinder; and
two side openings in the lateral curved surface of said cylinder.

2. The apparatus in accordance with claim 1 in which said side openings are dimensioned as elliptical openings.

3. The apparatus in accordance with claim 2 in which said side openings are located on opposite sides of the lateral curved surface of said cylinder from each other.

4. The apparatus in accordance with claim 1 in which said cylinder further comprises a bulbous upper rim around said upper, open circular face opening.

5. The apparatus in accordance with claim 1 in which said cylinder is made of a sturdy, rigid material.

6. The apparatus in accordance with claim 5 in which said cylinder is made of Polylactic acid (PLA) plastic.

7. An apparatus in accordance with claim 1 in which said cylinder is dimensioned to accept a piping bag.

8. An apparatus in accordance with claim 7 in which said cylinder is dimensioned to accept an 8-inch piping bag.

9. An apparatus in accordance with claim 7 in which said cylinder is dimensioned to accept a 10-inch piping bag.

10. An apparatus in accordance with claim 7 in which said cylinder is dimensioned to accept a 12-inch piping bag.

11. The apparatus of claim 1, in combination with a tipless piping bag.

12. The apparatus of claim 1, in combination with a tipped piping bag.

13. An apparatus for facilitating the filling of piping bags with icing comprising a tall, tapered, graduated cylinder, said cylinder comprising an open upper end and two elliptical side openings, said elliptical side openings being located on the lateral curved surface of said cylinder on opposite sides from each other.

14. The apparatus in accordance with claim 13 in which said cylinder is made of a sturdy, rigid material.

15. The apparatus in accordance with claim 13 in which said cylinder is made of Polylactic acid (PLA) plastic.

16. An apparatus in accordance with claim 13 in which said cylinder further comprises a bulbous upper rim around said upper end opening.

17. An apparatus in accordance with claim 13 in which said cylinder is dimensioned to accept an 8-inch piping bag.

18. An apparatus in accordance with claim 13 in which said cylinder is dimensioned to accept a 10-inch piping bag.

19. An apparatus in accordance with claim 13 in which said cylinder is dimensioned to accept a 12-inch piping bag.

20. A system for facilitating the filling of piping bags with icing comprising:
three tall, tapered, graduated cylinders, each of said cylinders comprising an open upper end having a bulbous upper rim and two elliptical side openings, said elliptical side openings being located on the lateral curved surface of said cylinders on opposite sides from each other, said cylinders being dimensioned to accept 8-inch, 10-inch, and 12-inch standard piping bags, respectively, said cylinders being made of a rigid material, said cylinders being dimensioned such that they can be nested inside each other.
